(19) United States
(12) Patent Application Publication
(10) Pub. No.: US 2007/0089270 A1
(43) Pub. Date: Apr. 26, 2007

(54) Dampended hinge for an electronic apparatus

(75) Inventors: Kuo-Chou Chang, Chunan (TW); Wei-Cheng Huang, Chunan (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/526,759

(22) Filed: Sep. 26, 2006

(30) Foreign Application Priority Data
Oct. 25, 2005 (TW) 94218440

(51) Int. Cl. E05F 1/14

(52) U.S. Cl. 16/285

(57) ABSTRACT

A dampened hinge used for pivoting a flip cover onto a cover case of an electronic apparatus comprises a pivot element, a first connector, a second connector, a shaft, a first torsion element, and a second torsion element. The pivot element connected to the flip cover is set between the first connector and the second connector fixed on the cover case of the electronic apparatus. The shaft inserted through the pivot element is fixed on the first connector and the second connector. The first and second torsion elements are sleeved on the shaft. One end of the first torsion element is fixed on the first connector, the other end of that extends in adjacent to anther side of the pivoting element. One end of the second torsion element is fixed on the second connector, the other end of that extends away from anther side of the pivoting element.

### RELATED APPLICATIONS

The present application is based on, and claims priority from, Taiwan Application Serial Number 94218440, filed Oct. 25, 2005, the disclosure of which is hereby incorporated by reference herein in its entirety.

### FIELD OF THE INVENTION

The present invention relates to a dampened hinge, and particularly relates to a dampened hinge for pivoting a flip cover onto a cover case of an electronic apparatus.

### BACKGROUND OF THE INVENTION

Typically, a flip cover is set on an electronic apparatus for several purposes, such as protecting the electronic apparatus from dust or impact, or even providing the electronic apparatus an elegant appearance. The flip cover may be hinged open when a user operates the electronic apparatus. After operation, devices of the electronic apparatus, such as buttons, speakers, connectors or electrical terminals, are sheltered by closing the flip cover.

FIG. 1 illustrates a flip cover of an electronic apparatus in accordance with the prior art, wherein one end of the flip cover 101 is pivoted on the cover case 103 of the electronic apparatus via a hub 102 to open or close the flip cover 101. When the flip cover 101 is hinged open via the hub 102, the end of the flip cover 101 opposite to the hub 102 rotates away from the cover case 103 and falls down rapidly due to gravity (following the arrow 104).

However, the flip cover 101 itself, the hub 102, and the cover case 103 may be damaged by this action, and the user may be struck or scratched by accidental impact with the falling flip cover 101. A larger flip cover 101 means even greater risk of damage or injury.

Therefore, it is a challenge for that skilled in the art to provide programs in resolving the aforementioned problems.

### SUMMARY OF THE INVENTION

The objective of the present invention is to provide a dampened hinge to pivot a flip cover onto a cover case of an electronic apparatus.

To achieve the above-mentioned objective, the present invention provides a dampened hinge comprising a pivot element, a first connector, a second connector, a shaft, a first torsion element, and a second torsion element. The pivot element has a shell portion and a connecting portion. The shell portion has a first opening and a second opening disposed at two ends thereof, and the connecting portion connects with the flip cover. The first connector is fixed on the cover case and disposed adjacent to the first opening. The second connector is fixed on the cover case and disposed adjacent to the second opening. The shaft is inserted through the shell portion and extending out of the first opening and second opening, one end of the shaft is fixed on the first connector and the other end of the shaft is fixed on the second connector. The first torsion element is sleeved on the shaft. One end of the first torsion element is fixed on the first connector and the other end of the first torsion element extends towards a side of the pivot element adjacent to the cover case. The first torsion element is pushed back for storing an elastic potential energy while the connecting portion rotates towards the cover case. The second torsion element is sleeved on the shaft. One end of the second torsion element is fixed on the second connector and the other end of the second torsion element extends towards a side of the pivot element away from the cover case. The second torsion element is pushed back for storing an elastic potential energy while the connecting portion rotates away from the cover case.

### BRIEF DESCRIPTION OF THE DRAWINGS

The foregoing aspects and many of the attendant advantages of this invention are more readily appreciated as the same become better understood by reference to the following detailed description, when taken in conjunction with an accompanying drawings, wherein:

FIG. 1 illustrates a flip cover of an electronic apparatus in accordance with the prior art FIG. 2A is an exploded view of a dampened hinge in accordance with a first embodiment of the present invention.

FIG. 2B is an assembled view of a dampened hinge in FIG. 2A.

FIG. 2C is a partially enlarged assembled view illustrating a flip cover pivoted on a cover case of an electronic apparatus by the dampened hinge shown in FIG. 2B.

FIG. 3A is an exploded view of a dampened hinge in accordance with a second embodiment of the present invention.

FIG. 3B is a partially enlarged assembled view illustrating a flip cover pivoted on a cover case of an electronic apparatus by the dampened hinge shown in FIG. 3A.

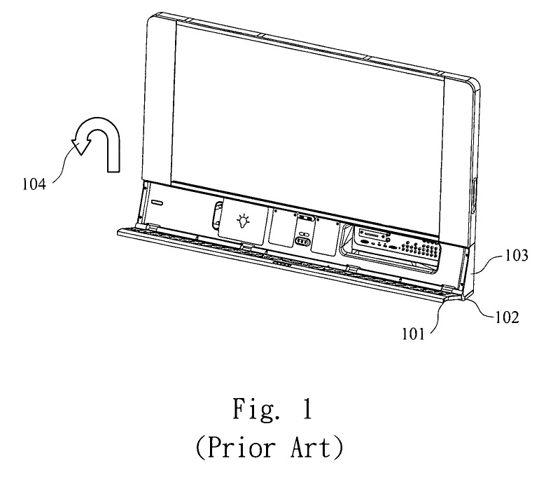

### DETAILED DESCRIPTION OF THE PREFERRED EMBODIMENT

### The First Embodiment

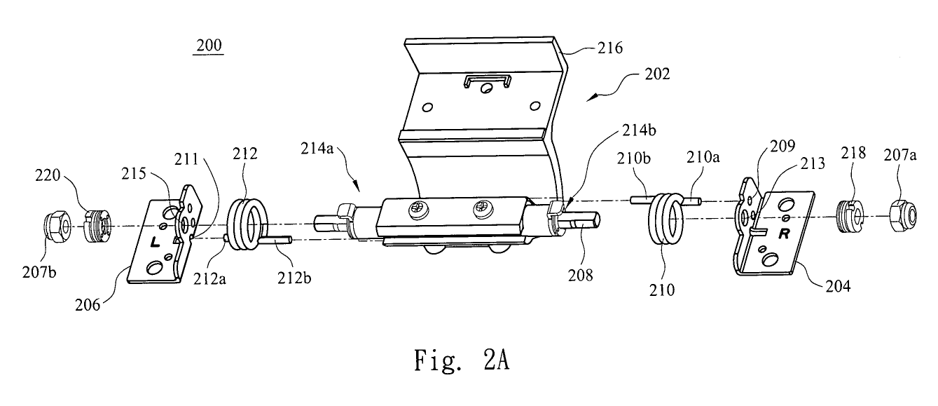

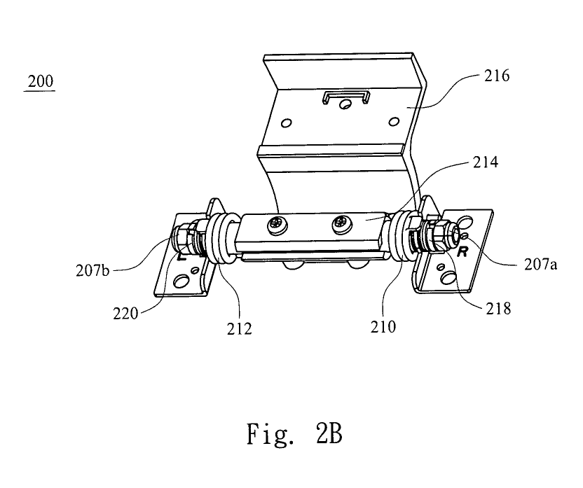

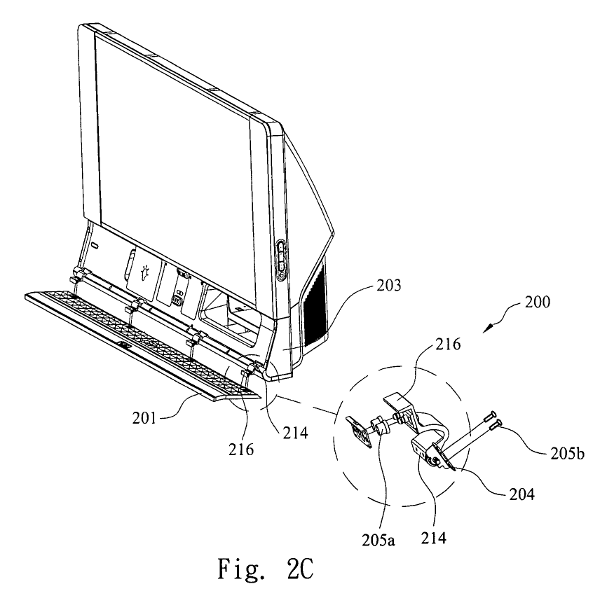

Referring to FIG. 2A to FIG. 2C, the dampened hinge 200 used for pivoting a flip cover 201 onto a cover case 203 of the electronic apparatus comprises a pivot element 202, a first connector 204, a second connector 206, a shaft 208, a first torsion element 210, and a second torsion element 212.

The pivot element 202 has a shell portion 214 and a connecting portion 216 that are connected with each other. The shell portion 214 having a first opening 214a and a second opening 214b disposed at two ends and allowing the shaft 208 inserted therethrough is disposed between the first connector 204 and the second connector 206. The connecting portion 216 is used to connect with the flip cover 201. The first connector 204 disposed adjacent to the first opening 214a and the second connector 206 disposed adjacent to the second opening 214b are fixed on the cover case 203 of the electronic apparatus, respectively.

Both ends of the shaft 208 inserted through the shell portion 214 extend out from the first opening 214a and the second opening 214b. One end of the shaft 208 is inserted through a first fixing hole 213 of the first connector 204 and fixed thereon by a first fastener 207a The other end of the shaft 208 is inserted through a second fixing hole 215 of the second connector 206 and fixed thereon by the second fastener 207b. The shaft 208 serves as a hub by which the pivot element 202 rotates around. In the present embodiment, the first fastener 207a and the second fastener 207b both comprise a screw and a nut

The first torsion element 210 is sleeved on one end of the shaft 208 and set between the shell portion 214 and the first connector 204. One end of the first torsion element 210 is fixed on the first connector 204 and the other end of the first torsion element 210 extends towards the side of the pivot element 202 adjacent to the cover case 203 of the electronic apparatus. In the present embodiment, the first torsion element 210 is a torsion spring having two engaging portions, such as the engaging portions 210a and 210b, extending from each end of the torsion spring. The engaging portion 210a bolts into the first bolting hole 209 of the first connector 204, and the engaging portion 210b extends towards the side of the pivot element 202 adjacent to the cover case 203 of the electronic apparatus.

The second torsion element 212 is sleeved on the other end of the shaft 208 and set between the shell portion 214 and the second connector 206. One end of the second torsion element 212 is fixed on the second connector 206 and the other end of the second torsion element 212 extends towards the side of the pivot element away from the cover case 203 of the electronic apparatus. In the present embodiment, the second torsion element 212 is a torsion spring having two engaging portions, such as the engaging portions 212a and 212b, extending from each end of the torsion spring, wherein the engaging portion 212a bolts into the second bolting hole 211 of the second connector 206, and the engaging portion 212b extends towards the side of the pivot element 202 opposite to the cover case 203 of the electronic apparatus.

In the present embodiment, the dampened hinge 200 further comprises a first washer 218 and a second washer 220. The first washer 218 is sleeved on one end of the shaft 208 and set between the first connector 204 and the first fastener 207a. The second washer 220 is sleeved on the other end of the shaft 208 and set between the second connector 206 and the second fastener 207b. When the connection portion 216 is forced by gravity, it rotates downward along with the shaft 208 that serves as a hub. Some of the gravity is counteracted by the friction between the first washer 218 and the first fastener 207a and counteract by the friction between the second washer 220 and the second fastener 207b to decelerate the connection portion 216.

The dampened hinge 200 is used to pivot the flip cover 201 with the cover case 203 of the electronic apparatus. The connecting portion 216 of the pivot element 202 is used to connect the flip cover 201 with the dampened hinge 200 that is fixed on the cover case 203 by the first connector 204 and the second connector 206. In the present embodiment of the present invention, a plurality of fasteners 205a, such as bolts, are used to connect the flip cover 201 with the connecting portion 216. The first connector 204 and the second connector 206 of the dampened hinge 200 are fixed on the cover case 203 of the electronic apparatus by a plurality of screw elements 205b, such as pairs of screws and nuts.

When the flip cover 201 is hinged to close by an external force, the flip cover 201 rotates along with the shaft 208 as a hub towards the cover case 203 of the electronic apparatus, while the engaging portions 210b is pushed by the connecting portion 216 to force the first torsion element 210 in reverse for storing an elastic potential energy that can recover the first torsion element 210. Therefore, when the flip cover 201 is hinged open, the elastic potential energy of the first torsion element 210 pushes the flip cover 201 away from the cover case 203 of the electronic apparatus, so as to create a gap between the cover case 203 and the flip cover 201.

When the connecting portion 216 is affected by gravity, the flip cover 201 rotates down along with the shaft 208 as a hub, while the engaging portions 212b are pushed to force the second torsion element 312 to reverse, whereby the elastic potential energy of the second torsion element 212 partially counteracts gravity to decelerate the connection portion 216.

### The Second Embodiment

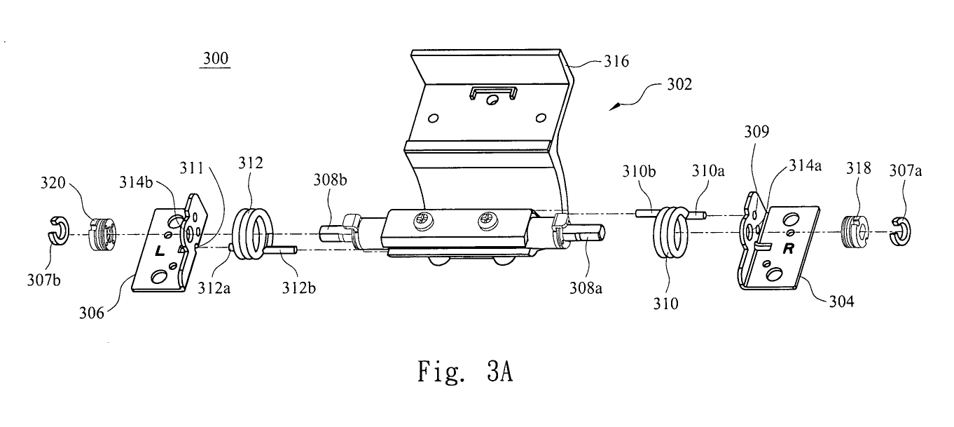

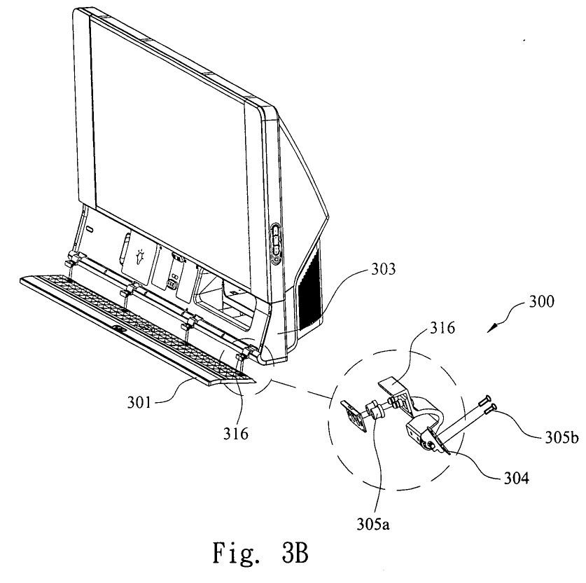

Referring to FIG. 3A and FIG. 3B, the dampened hinge 300 used for pivoting a flip cover 301 on to a cover case 303 of an electronic apparatus comprises a pivot element 302, a first connector 304, a second connector 306, a first torsion element 310, and a second torsion element 312.

The pivot element 302 has a first pivot portion 308a, a second pivot portion 308b and a connecting portion 316 that are connected with each other and formed integrally, wherein the connecting portion 316 is set between the first connector 304 and the second connector 306. The first pivot portion 308a and the second pivot portion 308b symmetrically protruding from the connecting portion 316 are pivoted on the first connector 304 and the second connector 306 respectively. The first connector 304 has pivot holes 314a allowing the first pivot portion 308a pivoted therein, and the second connector 306 has pivot holes 316a allowing the second pivot portion 308b pivoted therein. The first connector 304 and the second connector 306 serve as fulcrums for rotating the pivot element 302 along with the axis defined by the first pivot portion 308a and the second pivot portion 308b.

In the present embodiment, the dampened hinge 300 further comprises a first fastener 307a and second fastener 307b, wherein the first connector 304 is set between the connecting portion 316 and the first fastener 307a that is sleeved on the first pivot portion 308a used to prevent the first pivot portion 308a from sliding out of the pivot hole 314a, and the second connector 306 is set between the connecting portion 316 and the second fastener 307b that is sleeved on the second pivot portion 308b used to prevent the second pivot portion 308b from sliding out of the pivot hole 314b. In the present embodiment, the first fastener 307a and the second fastener 307b are two C-shaped buckles.

The first torsion element 310 is sleeved on the first pivot portion 308a and set between the connecting portion 316 and the first connector 304. One end of the first torsion element 310 is fixed on the first connector 304 and the other end of the first torsion element 310 extends towards the side of the pivot element 302 adjacent to the cover case 303 of the electronic apparatus. In the present embodiment, the first torsion element 310 is a torsion spring having two engaging portions, such as the engaging portions 310a and 310b, extending from each end of the torsion spring. The engaging portion 310a bolts into the first bolting hole 309 of the first connector 304 and the engaging portion 310b extends towards the side of the pivot element 302 adjacent to the cover case 303 of the electronic apparatus.

The second torsion element 312 is sleeved on the second pivot portion 308b and set between the connecting portion 316 and the second connector 306. One end of the second torsion element 312 is fixed on the second connector 306, and the other end of the second torsion element 312 extends towards the side of the pivot element 302 away from the cover case 303 of the electronic apparatus. In the present embodiment, the second torsion element 312 is a torsion spring having two engaging portions, such as the engaging portions 312a and 312b, extending from each end of the torsion spring. The engaging portion 312a bolts into the second bolting hole 311 of the second connector 306, and the engaging portion 312b extends towards the side of the pivot element 302 away from the cover case 303 of the electronic apparatus.

In the present embodiment, the dampened hinge 300 further comprises a first washer 318 and a second washer 320. The first washer 318 is sleeved on the first pivot portion 308a and set between the first connector 304 and the first fastener 307a. The second washer 320 is sleeved on the second pivot portion 308b and set between the second connector 306 and the second fastener 307b. When the connection portion 316 is forced by gravity, the connection portion 316 rotates downward along with the axis defined by the first pivot portion 308a and the second pivot portion 308b. Gravity is partly counteracted by the friction between the first washer 318 and the first fastener 307a and by the friction between the second washer 320 and the second fastener 307b to decelerate the connection portion 316.

The dampened hinge 300 is used to pivot the flip cover 301 with the cover case 303 of the electronic apparatus. The connecting portion 316 of the pivot element 302 is used to connect the flip cover 301 with the dampened hinge 300 that is fixed on the cover case 303 of the electronic apparatus by the first connector 304 and the second connector 306. In the present embodiment of the present invention, a plurality of fasteners 305, such as bolts, are used to connect the flip cover 301 with the connecting portion 316. The first connector 304 and the second connector 306 of the dampened hinge 300 are fixed on the cover case 303 of the electronic apparatus by a plurality of screw elements 305b, such as pairs of screws and nuts.

When the flip cover 301 is hinged closed by an external force, the flip cover 301 rotates along with the axis defined by the first pivot portion 308a and the second pivot portion 308b towards the cover case 303 of the electronic apparatus, while the engaging portions 310b is pushed by the connecting portion 316 to force the first torsion element 310 in reverse to store an elastic potential energy that can recover the first torsion element 310. Therefore, when the flip cover 301 is hinged open, the elastic potential energy of the first torsion element 310 pushes the flip cover 301 away from the cover case 303 of the electronic apparatus, so as to create a gap between the cover case 303 and the flip cover 301.

When the connecting portion 316 is affected by gravity, the flip cover 301 rotates downward along with the axis defined by the first pivot portion 308a and the second pivot portion 308b, meanwhile pushes the engaging portions 312b to force the second torsion element 312 to reverse, whereby the elastic potential energy of the second torsion element 312 partly counteract gravity to decelerate the connection portion 316.

According to the aforementioned embodiments, the features of the present invention are utilizing two torsion elements disposed adjacent to the pivot element to push the flip cover away from the cover case of the electronic apparatus and to prevent accidental impact due to the flip cover falling rapidly.

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

What is claimed is:

1. A dampened hinge used for pivoting a flip cover onto a cover case of an electronic apparatus, comprising:
a pivot element having a shell portion and a connecting portion, the shell portion having a first opening and a second opening disposed at two ends thereof, and the connecting portion being used to connect with the flip cover;
a first connector fixed on the cover case and disposed adjacent to the first opening;
a second connector fixed on the cover case and disposed adjacent to the second opening;
a shaft inserted through the shell portion and extending out of the first opening and second opening, one end of the shaft being fixed on the first connector and the other end of the shaft being fixed on the second connector;
a first torsion element being sleeved on the shaft and set between the shell portion and the first connector, wherein one end of the first torsion element is fixed on the first connector and the other end of the first torsion element extends towards a side of the pivot element adjacent to the cover case, while the connecting portion rotates towards the cover case, the first torsion element is pushed back for storing an elastic potential energy; and
a second torsion element being sleeved on the shaft and set between the shell portion and the first connector, one end of the second torsion element is fixed on the second connector and the other end of the second torsion element extends towards a side of the pivot element away from the cover case, while the connecting portion rotates away from the cover case, the second torsion element is pushed back for storing an elastic potential energy.

2. The dampened hinge in accordance with claim 1, wherein the first connector includes a first bolting hole used for fixing the first torsion element, and the second connector includes a second bolting hole used for fixing the second torsion element.

3. The dampened hinge in accordance with claim 1, wherein one end of the shaft is fixed on the first connector by a first fastener, and the other end of the shaft is fixed on the second connector by a second fastener.

4. The dampened hinge in accordance with claim 3, further comprising a first washer and a second washer, wherein the first washer is sleeved on the shaft and set between the first connector and the first fastener, and the second washer is sleeved on the shaft and set between the second connector and the second fastener.

5. The dampened hinge in accordance with claim 1, wherein the first torsion element is a torsion spring set between the shell portion and the first connector, and the second torsion element is a torsion spring set between the shell portion and the second connector.

6. A dampened hinge used for pivoting a flip cover onto a cover case of an electronic apparatus, comprising:
a pivot element having a first pivot portion, a second pivot portion, and a connecting portion, the first pivot portion and the second pivot portion symmetrically protruding from the connecting portion, and the connecting portion being connecting to the flip cover;
a first connector fixed on the cover case, wherein the first connector has a first pivot hole allowing the first pivot portion pivoted therein;
a second connector fixed on the cover case, wherein the second connector has a second pivot hole allowing the second pivot portion pivoted therein;
a first torsion element sleeved on the first pivot portion, wherein one end of the first torsion element is fixed on the first connector and the other end of the first torsion element extends towards a side of the pivot element adjacent to the cover case, while the connecting portion rotates towards the cover case, the first torsion element is pushed back for storing an elastic potential energy; and
a second torsion element sleeved on the second pivot portion, wherein one end of the second torsion element is fixed on the second connector and the other end of the second torsion element extends towards a side of the pivot element away from the cover case, while the connecting portion rotates away from the cover case, the second torsion element is pushed back for storing an elastic potential energy.

7. The dampened hinge in accordance with claim 6, further comprising a first fastener and second fastener, wherein the first fastener is sleeved on the first pivot portion and the first connector is set between the connecting portion and the first fastener; the second fastener is sleeved on the second pivot portion and the second connector is set between the connecting portion and the second fastener.

8. The dampened hinge in accordance with claim 7, further comprising a first washer and a second washer, wherein the first washer is sleeved on the first pivot element and set between the first connector and the first fastener, and the second washer is sleeved on the second pivot element and set between the second connector and the second fastener.

9. The dampened hinge in accordance with claim 6, wherein the first torsion element is a torsion spring set between the pivot element and the first connector, the second torsion element is a torsion spring set between the pivot element and the second connector.
